(19) United States
(12) Patent Application Publication
(10) Pub. No.: US 2010/0069078 A1
(43) Pub. Date: Mar. 18, 2010

(54) METHOD OF CONTROLLING CALL SETUP IN WIRELESS COMMUNICATION SYSTEM

(75) Inventors: Sung-gu Choi, Daejeon (KR); Yeon-Seung Shin, Daejeon (KR); Yeon-Jin Kim, Daejeon (KR)

Correspondence Address: Muncy, Geissler, Olds & Lowe, PLLC, P.O. BOX 1364, FAIRFAX, VA, 22038-1364, US

(73) Assignee: ELECTRONICS AND TELECOMMUNICATIONS RESEARCH INSTITUTE, Daejeon (KR)

(21) Appl. No.: 12/516,872

(22) PCT Filed: Aug. 7, 2007
(86) PCT No.: PCT/KR2007/003799

§ 371 Date: May 29, 2009

(30) Foreign Application Priority Data
Dec. 1, 2006 (KR) 10-2006-0120591
Feb. 2, 2007 (KR) 10-2007-0010955

(51) Int. Cl. H04W 72/04

(52) U.S. Cl. 455/450; 375/260

(57) ABSTRACT

The present invention is a method of controlling call setup, which accepts a request for setting a call when a first ratio of free resource blocks for uplink during a first monitoring unit time just before receiving the request is more than or equal to a first call acceptance threshold for uplink and a second ratio of free resource blocks for downlink during the first monitoring unit time is more than or equal to a second call acceptance threshold for downlink. When the first ratio is less than the first call acceptance threshold or the second ratio is less than the second call acceptance threshold, the call is queued for a queuing unit time. The call is accepted when a ratio of free resource blocks for uplink during a second monitoring unit time just before terminating the queuing unit time is more than or equal to the first call acceptance threshold and a ratio of free resource blocks for downlink during the second monitoring unit time is more than or equal to the second call acceptance threshold.

### TECHNICAL FIELD

The present invention relates to a method of controlling call setup in a wireless communication system. More particularly, the present invention relates to a method of controlling call setup in an orthogonal frequency division multiplexing (hereinafter referred to as “OFDM”) wireless communication system.

This work was supported by the IT R&D program of MIC/IITA [2005-S-404-22, Research and development on 3G long-term evolution access system].

### BACKGROUND ART

Controlling call setup is that a base station determines whether to accept a call setup request from a terminal or not. Objects of controlling call setup are to minimize negative effect on service of an established call because of accepting a new call and to maximize using efficiency of data transmission resources of a base station.

Controlling call setup of a base station is an important function that affects service quality and network efficiency.

Prior arts about controlling call setup in an OFDM wireless communication system use various methods of radio resource allocation to control service efficiently. One method of radio resource allocation is to allocate all radio resources sequentially as often as a call setup request is received. But the method increases a call-blocking rate. As a result, the method cannot satisfy predetermined QoS (Quality of Service) in a system so system performance and efficiency are deteriorates.

Thus a new method of radio resource allocation that can support various multimedia traffic is necessary.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

It is an object of the present invention to provide a method of controlling call setup in a wireless communication system having advantages of minimizing a call blocking rate.

### Technical Solution

In one aspect of the present invention, a method of controlling a call setup in a base station of a wireless communication system includes: receiving a request for setting a call from a terminal; calculating a first ratio of free resource blocks for downlink to all resource blocks for downlink during a first monitoring unit time; calculating a second ratio of free resource blocks for uplink to all resource blocks for uplink during the first monitoring unit time; and accepting the request if the first ratio is more than or equal to a first call acceptance threshold for downlink and the second ratio is more than or equal to a second call acceptance threshold for uplink.

In another aspect of the present invention, a method of controlling a call setup in a base station of a wireless communication system includes: receiving a request for setting a call from a terminal; calculating at least one of a first ratio of free resource blocks for downlink to all resource blocks for downlink during a first monitoring unit time and a second ratio of free resource blocks for uplink to all resource blocks for uplink during the first monitoring unit time; and queuing the call for a queuing unit time if the first ratio is less than a first call acceptance threshold for downlink or the second ratio is less than a second call acceptance threshold for uplink.

In still another aspect of the present invention, a method of controlling a call setup in a base station of a wireless communication system includes: receiving a request for setting a call from a terminal; queuing the call for a queuing unit time if a first number of free resource blocks for downlink during a first monitoring unit time is less than a first call acceptance threshold, or a second number of free resource blocks for uplink during the first monitoring unit time is less than a second call acceptance threshold; and determining whether or not to accept the call using at least one of a third number of free resource blocks for downlink during a second monitoring unit time and a fourth number of free resource blocks for uplink during the second monitoring unit time after the queuing unit time.

### ADVANTAGEOUS EFFECTS

As described above, a method of controlling call setup of the present invention manages a request for setting a call after a queuing unit time if ratios of free resource blocks are less than call acceptance thresholds. Thus, the present invention minimizes a call blocking rate and satisfy QoS (quality of service) and maximizes system performance and efficiency.

### BRIEF DESCRIPTION OF THE DRAWINGS

FIG. 1 is a schematic block diagram of a wireless communication system according to an exemplary embodiment of the present invention.

FIG. 2 is a drawing showing allocation status of resource blocks managed in a base station in accordance with the exemplary embodiment of the present invention.

FIG. 3 is a schematic view of a resource block used for management of data transmission resources in a base station in accordance with the exemplary embodiment of the present invention.

FIG. 4 is a flow chart showing a method of controlling call setup of the base station in the wireless communication system in accordance with the exemplary embodiment of the present invention.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, unless explicitly described to the contrary, the word “comprise” and variations such as “comprises” or “comprising” will be understood to imply the inclusion of stated elements but not the exclusion of any other elements.

Method of controlling call setup in the wireless communication system in accordance with the exemplary embodiment of the present invention will be described.

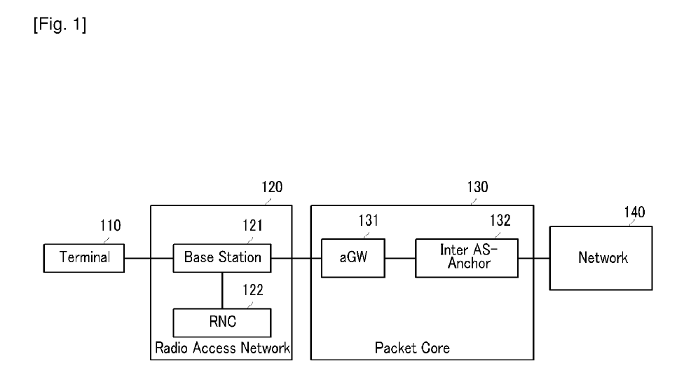

FIG. 1 is a schematic block diagram of a wireless communication system according to an exemplary embodiment of the present invention. The OFDM 3 Generation Evolution (3GE) wireless system is described as an example in an exemplary embodiment of the present invention, but the present invention is also applied in other wireless communication systems.

As shown in FIG. 1, a wireless communication system according to an exemplary embodiment of the present invention includes a terminal 110, a radio access network (RAN) 120, a packet core 130, and a network 140.

The RAN120 communicates with the terminal 110 by wireless and connects to the network 140 by wired communication with the packet core 130. The network 140 can be an Internet protocol (IP) network, for example. The RAN 120 includes at least one base station 121 and a radio network controller (RNC) 122. The base station 121 is called an evolved node B(eNode B) in the 3GE system. The RNC 122 delivers data from the packet core 130 to the base station 121, and works as a base station controller that controls the base station 121. The base station 121 communicates with the terminal 110 and controls acceptance of a request for setting a call from the terminal 110 according to a ratio of free data transmission resources. A function of the base station 121 is divided into a user area and a control area. The user area is in charge of user data transmission and the control area is in charge of various controls and signaling. Controlling call setup is carried out by a radio admission control area of the control area.

The packet core 130 provides a function of mobility management or session management, and a connection of an exterior network. The packet core 130 in the 3GE system is called an evolved packed core (ePC) and includes an access gate-way (aGW) and an inter-AS anchor 132

The aGW 131 controls the base station 121, and the inter-AS anchor 132 provides a function of efficient handover between different kinds of access networks. Particularly, the 3GE system provides a linkage to a 3GPP system and a linkage and handover to a non-3GPP system like a WLAN (wireless local area network) as a requirement of the 3GPP (3rd generation partnership project) SAE (system architecture evolution). Thus the terminal 110 works in the WLAN and 3GE systems.

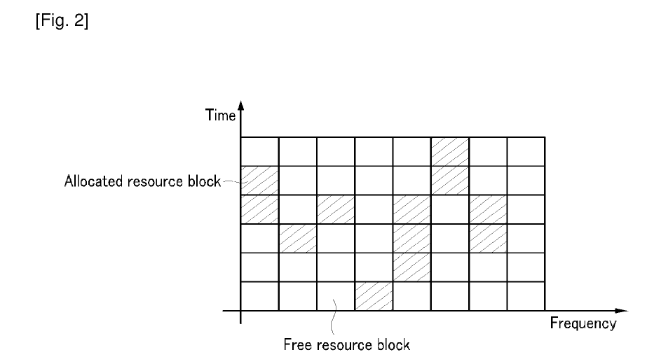

A method of controlling call setup in the base station 121 as a ratio of free data transmission resources according to an exemplary embodiment of the present invention will be fully described, referring to FIG. 2 to FIG. 4.

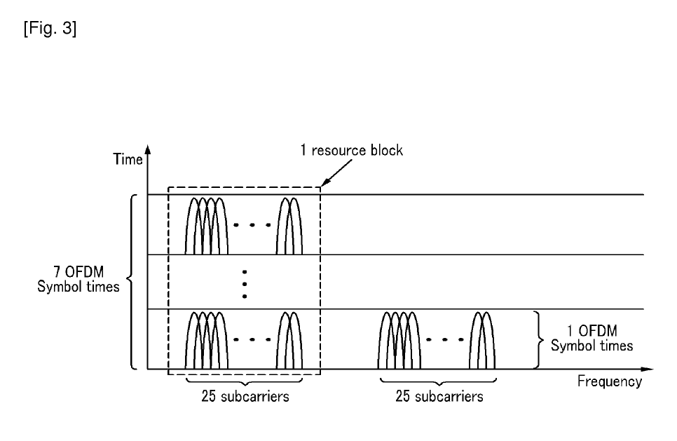

First, a method of managing data transmission resource in base station 121 according to an exemplary embodiment of the present invention will be described referring to FIG. 2 and FIG. 3

FIG. 2 is a drawing showing allocation status of resource block managed in a base station in accordance with the exemplary embodiment of the present invention, and FIG. 3 is a schematic view of a resource block used for management of data transmission resources in a base station in accordance with the exemplary embodiment of the present invention.

A resource block is a resource unit used when the base station 121 transmits data to the terminal 110 and the terminal 110 transmits data to the base station 121. As shown in FIG. 2, the base station 121 divides allocated OFDM symbol time as a plurality of symbol groups and allocated subcarriers as a plurality of subcarrier groups, and defines an area formatted with each symbol group and each subcarrier group as a resource block. So, all free resource blocks in the base station 121 can be expressed as lattice elements on a time axis and a frequency axis, and each lattice element represents one resource block. Allocating resource blocks when receiving a request for data transmission is the same as allocating lattice elements.

For example, as shown in FIG. 3, one resource block can be defined with 7 OFDM symbol times and 25 subcarriers.

The base station 121 waits until free resource blocks are available and can transmit data when the base station 121 wants to transmit data to the terminal 110. The same occurs when the terminal 110 wants to transmit data to the base station 121. A MAC (Media Access Control) layer of the base station 121 determines an allocation of resource blocks for data transmission dynamically, and the allocation is available for a predetermined unit time and after the predetermined unit time the allocation is repeated. The base station 121 has limited resource blocks for a unit time so data transmission capacity for the unit time is restricted.

A single resource block or a plurality of resource blocks can be allocated for data transmission. If data transmission cannot be completed with one resource block, more resource blocks can be allocated. A resource block can be extended on the time axis and the frequency axis when allocating a plurality of resource blocks. Allocation of a plurality of resource blocks on the time axis is allocating the same subcarrier group several times, and allocation of a plurality of resource blocks on the frequency axis is allocating several subcarrier groups simultaneously.

The base station 121 manages statuses of resource block allocations for uplink and downlink separately. Additionally, the base station 121 manages resource blocks for downlink, that is, resource blocks for transmission from the base station 121 to the terminal 110, and resource blocks for uplink, that is, resource blocks for transmission from the terminal 110 to the base station 121, separately. The resource block allocation status shown in FIG. 2 represents one of uplink or downlink.

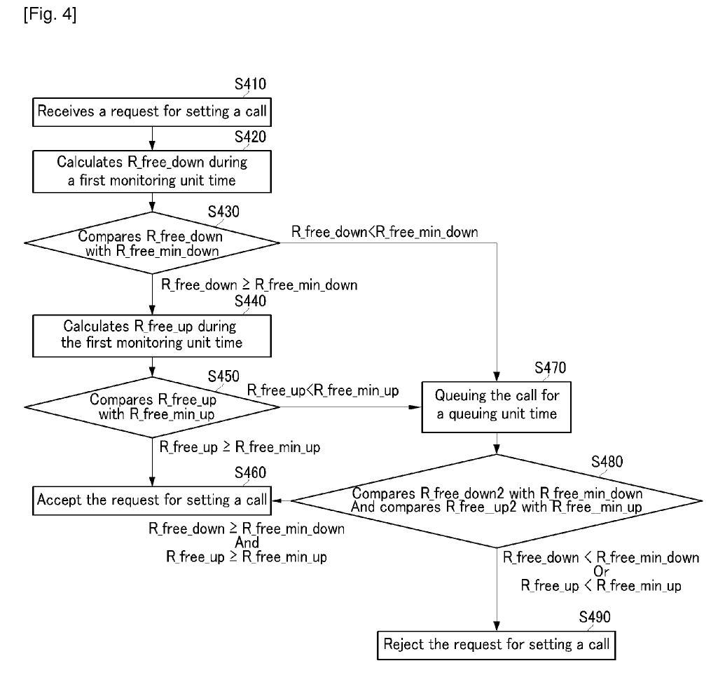

A method of controlling acceptance of a request for setting a call from the terminal 110 using resource blocks in the base station 121 will be described referring to FIG. 4.

FIG. 4 is a flow chart showing a method of controlling call setup of the base station in the wireless communication system in accordance with the exemplary embodiment of the present invention.

As shown in FIG. 4, as the base station 121 receives a request for setting a call from the terminal 110 (S410), the base station 121 calculates a ratio of free resource blocks for downlink (R_free_down) during a first monitoring unit time just before receiving the request, as Equation 1 (S420).

R_free_down=N_free_rb_down/N_total_rb_down (Equation 1)

N_total_rb_down is a number of all resource blocks for downlink during the first monitoring unit time, and N_free_rb_down is a number of free resource blocks for downlink during the first monitoring unit time. So the value of the ratio of free resource blocks for downlink is between 0 and 1.

In the example of FIG. 2, the number of all resource blocks (N_total_rb_down) is 48, and the number of allocated resource blocks is 12 and the number of free resource blocks (N_free_rb_down) is 36, so a ratio of free resource blocks (R_free_down) is 0.75

The length of the first monitoring unit time can be determined appropriately

If the length of the first monitoring unit time is too short, the overall status of using resources of the base station 121 cannot be observed. If the length of the first monitoring unit time is too long, the base station 121 cannot confront a change of status of using resources. In an exemplary embodiment of the present invention, the first monitoring unit time is determined as integer times of a time unit of a resource block and can be determined by experiment.

The base station 121 compares the ratio of free resource blocks for downlink (R_free_down) with a first call acceptance threshold for downlink (R_free_min_down) (S430). The first call acceptance threshold for downlink (R_free_min_down) is a value between 0 and 1, and is a minimum ratio of free resource blocks for downlink to accept the request for setting a call.

Exemplary embodiments of the present invention do not present the first call acceptance threshold for downlink (R_free_min_down). If the first call acceptance threshold for downlink (R_free_min_down) is too high, the use rate of resource of the base station 121 will decrease. If the first call acceptance threshold for downlink (R_free_min_down) is too low, service quality of an established call can become deteriorated because the probability of acceptance of a new call increases. A network operator can determine the first call acceptance threshold for downlink (R_free_min_down) by experiment.

If the ratio of free resource blocks for downlink (R_free_down) is less than the first call acceptance threshold for downlink (R_free_min_down), the call is queued for a queuing unit time (S470). If the ratio of free resource blocks for downlink (R_free_down) is more than or equal to the first call acceptance threshold for downlink (R_free_min_down), the base station 121 calculates a ratio of free resource blocks for uplink (R_free_up) during the first monitoring unit time just before receiving the request for setting a call as Equation 2(S440).

R_free_up=N_free_rb_up/N_total_rb_up (Equation 2)

N_total_rb_up is a number of all resource blocks for uplink during the monitoring unit time, and N_free_rb_up is a number of free resource blocks for uplink during the monitoring unit time.

The base station 121 compares the ratio of free resource blocks for uplink (R_free_up) with a second call acceptance threshold for uplink (R_free_min_up) (S450). If the ratio of free resource block for uplink (R_free_up) is less than the second call acceptance threshold for uplink (R_free_min_up), the call is queued for the queuing unit time (S470). If the ratio of free resource blocks for uplink (R_free_up) is more than or equal to the second call acceptance threshold for uplink (R_free_min_up), the base station 121 accept the request (S460).

After the call is queued for the queuing unit time, the base station 121 calculates ratios of free resource blocks for downlink and uplink during a monitoring unit time just before terminating a queuing unit time, and compares them with the first call acceptance threshold and the second call acceptance threshold (S480). If the ratios of free resource blocks for downlink and uplink are more than or equal to the first call acceptance threshold and the second call acceptance threshold, the base station 121 accepts the call (S460). If the ratio of free resource blocks for uplink during the monitoring unit time just before terminating the queuing unit time is less than the first call acceptance threshold or the ratio of free resource blocks for downlink during the monitoring unit time just before terminating the queuing unit time is less than the second call acceptance threshold, the base station 121 rejects the call (S490).

FIG. 4 presents that the base station 121 calculates a ratio of free resource blocks for downlink first but the base station 121 can calculate a ratio of free resource blocks for uplink first.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of controlling a call setup in a base station of a wireless communication system, the method comprising:
receiving a request for setting a call from a terminal;
calculating a first ratio of free resource blocks for downlink to all resource blocks for downlink during a first monitoring unit time;
calculating a second ratio of free resource blocks for uplink to all resource blocks for uplink during the first monitoring unit time; and
accepting the request if the first ratio is more than or equal to a first call acceptance threshold for downlink and the second ratio is more than or equal to a second call acceptance threshold for uplink.

2. The method of claim 1, further comprising
queuing the call for a queuing unit time if the first ratio is less than the first call acceptance threshold or the second ratio is less than the second call acceptance threshold.

3. The method of claim 2, further comprising:
calculating a third ratio of free resource blocks for downlink to all resource blocks for downlink during a second monitoring unit time after the queuing unit time;
calculating a fourth ratio of free resource blocks for uplink to all resource blocks for uplink during the second monitoring unit time after the queuing unit time; and
accepting the request if the third ratio is more than or equal to the first call acceptance threshold and the fourth ratio is more than or equal to the second call acceptance threshold.

4. The method of claim 2, further comprising:
calculating at least one of the third ratio and the fourth ratio after the queuing unit time; and
rejecting the request if the third ratio is less than the first call acceptance threshold or the fourth ratio is less than the second call acceptance threshold.

5. The method of claim 1, wherein
the first monitoring unit time is a monitoring unit time just before receiving the request.

6. A method of controlling a call setup in a base station of a wireless communication system, the method comprising:
receiving a request for setting a call from a terminal;
calculating at least one of a first ratio of free resource blocks for downlink to all resource blocks for downlink during a first monitoring unit time and a second ratio of free resource blocks for uplink to all resource blocks for uplink during the first monitoring unit time; and
queuing the call for a queuing unit time if the first ratio is less than a first call acceptance threshold for downlink or the second ratio is less than a second call acceptance threshold for uplink.

7. The method of claim 6, further comprising:
calculating a third ratio of free resource blocks for downlink to all resource blocks for downlink during a second monitoring unit time after the queuing unit time;
calculating a fourth ratio of free resource blocks for uplink to all resource blocks for uplink during the second monitoring unit time after the queuing unit time; and
accepting the request if the third ratio is more than or equal to the first call acceptance threshold and the fourth ratio is more than or equal to the second call acceptance threshold.

8. The method of claim 6, further comprising;
calculating at least one of the third ratio and the fourth ratio after the queuing unit time; and
rejecting the request if the third ratio is less than the first call acceptance threshold or the fourth ratio is less than the second call acceptance threshold.

9. The method of claim 6, wherein
the first monitoring unit time is a monitoring unit time just before receiving the request.

10. A method of controlling a call setup in a base station of a wireless communication system, the method comprising:
receiving a request for setting a call from a terminal;
queuing the call for a queuing unit time if a first number of free resource blocks for downlink during a first monitoring unit time is less than a first call acceptance threshold, or a second number of free resource blocks for uplink during the first monitoring unit time is less than a second call acceptance threshold; and
determining whether or not to accept the call using at least one of a third number of free resource blocks for downlink during a second monitoring unit time and a fourth number of free resource blocks for uplink during the second monitoring unit time after the queuing unit time.

11. The method of claim 10, further comprising
accepting the call if the first number is more than or equal to the first call acceptance threshold and the second number is more than or equal to the second call acceptance threshold.

12. The method of claim 10, wherein
the determining comprises accepting the request if a third number of free resource blocks for downlink during a second monitoring unit time is more than or equal to the first call acceptance threshold and a fourth number of free resource blocks for uplink during the second monitoring unit time is more than or equal to the second call acceptance threshold after the queuing unit time.

13. The method of claim 10, wherein
the determining comprises rejecting the request if the third number is less than the first call acceptance threshold or the fourth number is less than the second call acceptance threshold after the queuing unit time.

14. The method of claim 10, wherein
the first monitoring unit time is a monitoring unit time just before receiving the request and the second monitoring unit time is a monitoring unit time just before terminating the queuing unit time.
